(19) United States
(12) Patent Application Publication
(10) Pub. No.: US 2017/0331853 A1
(43) Pub. Date: Nov. 16, 2017

(54) SECURITY SYSTEM

(71) Applicant: Allied Telesis Holdings K.K., Tokyo (JP)

(72) Inventor: Jun Kawakita, Tokyo (JP)

(21) Appl. No.: 15/456,192

(22) Filed: Mar. 10, 2017

(30) Foreign Application Priority Data
May 11, 2016 (JP) 2016-95060

(51) Int. Cl. H04L 29/06

(52) U.S. Cl. CPC H04L 63/1441; H04L 63/1416; H04L 2463/121

(57) ABSTRACT

A security system which performs predetermined control processing to a computer in a private network and is provided outside the private network, in which the security system which receives a global address which is a target of a threat from a threat detection system which detects the threat from an illegal attack server, specifies a local address corresponding to the received global address by referring to, based on the received global address, a translation table, which is included in a gateway in the private network, between the global address and the local address, and performs, from outside of the private network, predetermined control processing to communication of the computer in the private network using the specified local address.

### BACKGROUND

### Technical Field

The present invention relates to a security system in a network. The present invention particularly relates to a security system which maintains security by performing, when a computer terminal (hereinafter, referred to as a “client terminal”) in a private network, such as a LAN, receives a threat, such as an illegal attack, from a computer in a global network, such as the internet, disconnection or the like of communication of the client terminal in the private network from the private network.

### Related Art

There is address information, such as an IP address, to specify a computer in a network. The address information includes a local address used in a private network and a global address used in a global network. When a client terminal in a private network accesses a global network, it is common that a local address of the client terminal is NAT/PAT-translated into the global address, and the translated address is used for the access.

The NAT/PAT translation is performed by a device called a gateway, and the gateway includes a NAT/PAT table in which the local address and the global address are associated with each other.

On the other hand, in the global network, there is a computer to launch a cyber attack against the client terminal. A network manager operates a system to detect a threat, such as a cyber attack (hereinafter, referred to as a “threat detection system”) or a security system having various functions in order to defend their own private network and client terminals therein against the cyber attack. The security system has a function for countermeasures against a firewall or spyware, a function for preventing virus infection, or the like as a role thereof. Such security systems are required to prevent other client terminals from being infected when a client terminal is infected with a virus.

In the case in which the security system operates outside the private network, although the threat detection system detects a cyber attack, the local address of the attacked client terminal cannot be grasped since the communication is performed with the global address, and it is impossible to perform a defense, such as disconnection or the like of the communication only of the attacked client terminal. As a result, the communication of the private network itself should be disconnected, and which causes the disconnection of the communication of other client terminals in the private network which are not attacked, and the business or the like is greatly affected.

Thus, conventional security systems have mainly operated in private networks. However, security systems have sometimes needed to operate outside private networks recently to handle various threats and to monitor a plurality of private networks.

Thus, the invention disclosed in JP 2011-109186 A identifies a host (client terminal) which transmits a packet by identifying and translating a transmission source MAC address included in header information in the packet of a router communicating in a LAN.

### SUMMARY

However, when communication is performed between hosts which belong to a different network, conventionally, a NAT router (packet relay device) has transmitted the MAC address of the router to which the MAC address of a host at a transmission starting end is rewritten as a transmission source MAC address at the time when a packet is transmitted from the host to the NAT router. Thus, when a packet is transmitted from another host in the network to which the transmission starting end host belongs, it has been impossible to identify these hosts. The invention disclosed in JP 2011-109186 A resolves the problem. In other words, the problem is resolved by transmitting, as the transmission source MAC address, not the MAC address of the router, but the MAC address of the host by the NAT router when the host at the transmission starting end transmits a packet to the NAT router.

However, the MAC address of the host which can specify the host constantly flows to the global network outside the NAT router, which enables an illegal access to the host using the address, and causes a security problem. Furthermore, breakdown or a setting error of an access management device may transmit an irregular illegal packet to the global network, and which is a systemically undesirable problem. Moreover, to identify the transmission source host based on the transmission source MAC address of the packet, the packet relay device needs a function to add the MAC address to all of the packets transmitted from the host.

The inventor has taken the above problems into consideration and devised a security system according to an embodiment of the present invention.

A first aspect of the present invention is a security system which performs predetermined control processing to a computer in a private network and is provided outside the private network, in which the security system receives a global address which is a target of a threat from a threat detection system which detects the threat from an illegal attack server, specifies a local address corresponding to the received global address by referring to, based on the received global address, a translation table, which is included in a gateway in the private network, between the global address and the local address, and performs, from outside the private network, predetermined control processing to communication of the computer in the private network using the specified local address.

With the configuration of the aspect of the present invention, it is possible to grasp the local address of the computer in the private network although the security system is provided outside the private network. It is possible to specify only a computer which is a target of a threat based on the local address, and perform predetermined control, such as disconnection or the like of the communication accordingly. Thus, disconnection or the like of the communication of the entire private network is not required, and it is possible to reduce the influence on other computers.

In the aspect of the present invention, the security system may cause, by notifying the computer in the private network of performed control processing and date and time information, a log server to record the performed control processing.

With the configuration of the aspect of the present invention, it is possible to record the control processing for a defense performed by the security system. It is possible to contribute a forensic analysis accordingly.

Another aspect of the present invention can be as follows. In other words, the other aspect of the present invention is a security system provided outside a private network, in which the security system receives a global address which is a target of a threat and date and time information indicating when the threat is detected from a threat detection system which detects the threat from an illegal attack server, and specifies a local address corresponding to the global address at a time when the threat is detected by referring to, based on the received date and time information and the received global address, a log server which records a correspondence relation between a time stamp and information on translation between the global address and the local address in a gateway in the private network.

With the configuration of the aspect of the present invention, it is possible to specify that the global address corresponds to which local address from when until when, and contribute a digital forensic analysis. Furthermore, in the case in which the timing when the threat detection system detects the threat is deviated from the timing of the notification thereof, and the NAT/PAT translation table of the gateway is rewritten at the time when the security system receives the notification of the threat, it is possible to specify the correct local address by referring to the log server based on the date and time information indicating when the threat is detected.

By performing the processing method of the aspect of the present invention, a second aspect of the present invention can be implemented. In other words, the second aspect of the present invention is a security processing method in a computer network including a security system provided outside a private network, a threat detection system which detects a threat from an illegal attack server, and a gateway, which includes a translation table between a global address and a local address, in the private network, the security processing method includes receiving, by the security system, a global address which is a target of the threat from the threat detection system which detects the threat from the illegal attack server, specifying, by the security system, a local address corresponding to the global address by referring to, based on the received global address, a translation table of the gateway, and performing, by the security system, predetermined control processing to communication of the computer in the private network using the specified local address.

By performing the processing method of the aspect of the present invention, a third aspect of the present invention can be implemented. In other words, the third aspect of the present invention is a security processing method in a computer network including a security system provided outside a private network, a threat detection system which detects a threat from an illegal attack server, and a log server which records a correspondence relation between a time stamp and information on translation between a global address and a local address in a gateway which translates the global address and the local address in the private network, the security processing method including receiving, by the security system, a global address which is a target of the threat and date and time information indicating when the threat is detected from a threat detection system which detects the threat from the illegal attack server, and specifying, by the security system, a local address corresponding to the global address at a time when the threat is detected by referring to the log server based on the received date and time information and the received global address.

### Advantageous Effects of Invention

By using a security system according to an embodiment of the present invention, it is possible to specify a client terminal in a private network although the security system operates outside the private network. Then, by specifying the damaged client terminal, it is possible to perform disconnection or the like only of the communication of the client terminal. Thus, other client terminals which do not receive an attack in the private network are not affected.

### BRIEF DESCRIPTION OF DRAWINGS

FIG. 1 is a diagram schematically illustrating an entire configuration in a first embodiment of the present invention;

FIG. 2 is a diagram schematically illustrating an example of a hardware configuration of a computer according to an embodiment of the present invention;

FIG. 3 is an example of a flowchart in the first embodiment of the present invention;

FIG. 4 is a diagram schematically illustrating an example of a NAT/PAT translation table; and

FIG. 5 is a diagram schematically illustrating a processing example when a security system according to an embodiment of the present invention is employed.

### DETAILED DESCRIPTION

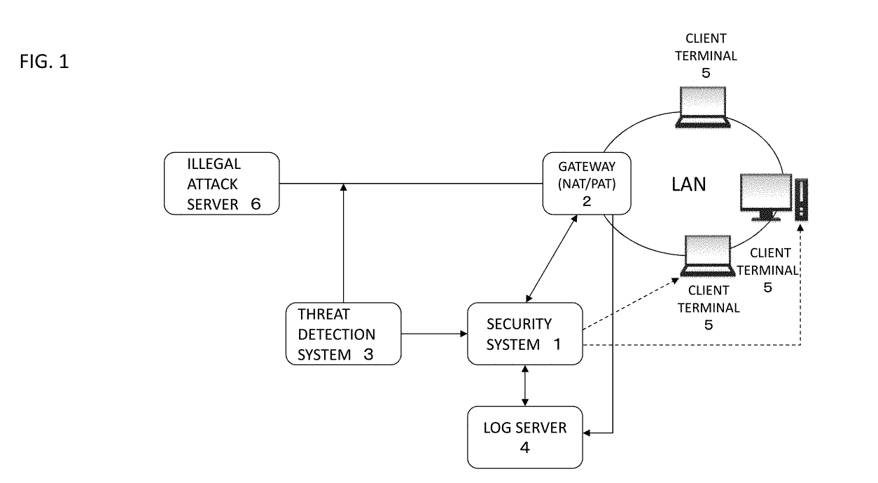

FIG. 1 schematically illustrates an entire configuration using a security system 1 according to an embodiment of the present invention. FIG. 1 illustrates the case in which there are three client terminals 5 (terminals A to C) in a LAN which is a private network constructed by a company or the like. Furthermore, a threat detection system 3 and the security system 1 according to the embodiment of the present invention are provided outside the private network (outside a router which is a gateway to be described). Note that, although not illustrated, the client terminal 5 communicates through a switch (relay device) connected to the private network with a port.

The threat detection system 3 monitors communication between a global network and a private network, and detects a cyber attack launched by an illegal attack server 6 from the global network. When detecting a threat, the threat detection system 3 notifies the security system 1 of an IP address of a transmission destination in a detected packet as a global address of the client terminal 5 to be attacked. The cyber attack includes various types of attacks of, for example, a denial of service (Dos) attack, a distributed denial of service (DDoS) attack, a port scan attack, and a ping of death (PoD) attack, but is not limited to the above.

The security system 1 is a computer system which performs a defense, such as disconnection of communication, or detection, isolation, or restoration of a virus, against a threat from the illegal attack server 6. Note that, the network is constructed so that the security system 1 can access a computer in the private network although the security system 1 is positioned outside the private network.

At the boundary between the private network and the global network, there is a router which is a gateway 2 and performs NAT/PAT translation. The router which is the gateway 2 associates the global address and the local address with each other and stores them in order for the client terminal 5 in the private network to access the global network. Note that, the router which is the gateway 2 performs NAT translation or PAT translation, but may use both translation methods, and they are collectively called NAT/PAT translation. FIG. 4 schematically illustrates an example of a NAT/PAT table managed by the router which is the gateway 2. Furthermore, the translation between the global address and the local address is not limited to the NAT/PAT translation, and a translation table between the global address and the local address is only required if the translation is needed.

When the security system 1 performs control processing for a predetermined defense, such as disconnection or the like of communication of the client terminal 5, a log server 4 is notified of contents of the control processing from the security system 1 and records the contents. The log server 4 associates date and time when the control processing is performed and the control processing with each other and records them. The control processing to be recorded includes the local address of the target client terminal 5, the identification information thereof (MAC address or the like), the contents of the performed control processing (disconnection of communication, or detection, isolation, or restoration of a virus).

Furthermore, the log server 4 receives a history of the NAT/PAT translation together with a time stamp from the gateway 2, associates them with each other and records them.

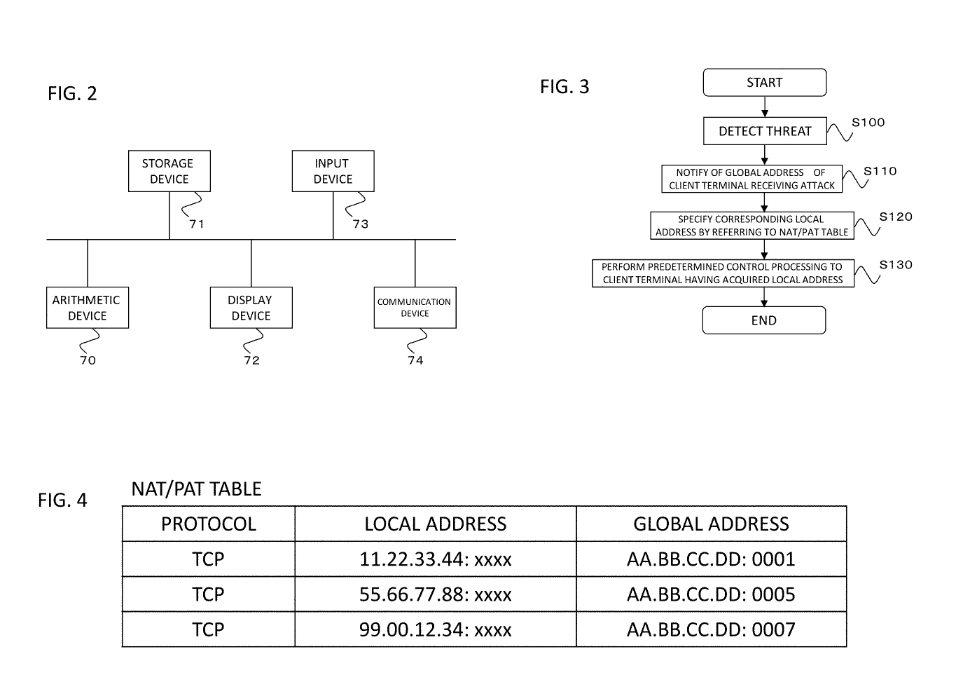

Note that, the embodiment of the present invention is implemented by various computers, such as a server and a personal computer. FIG. 2 illustrates an example of a hardware configuration of a computer. The computer includes an arithmetic device 70, such as a CPU to execute arithmetic processing of a program, a storage device 71, such as a RAM or a hard disk to store information, a display device 72, such as a display, an input device 73, such as a keyboard or a pointing device (a mouse or a numeric key), and a communication device 74 to transmit or receive a processing result of the arithmetic device 70 or the information to be stored in the storage device 71 through a network, such as the internet or a LAN.

Note that, FIG. 1 illustrates the case in which each device is implemented by one computer, but the function may be implemented by being dispersedly arranged in a plurality of computers. Furthermore, the functions of the means in the present invention are logically distinguished from each other, but may be physically or practically in the same region.

The processing units in the present invention are logically distinguished from each other, but may be physically or practically in the same region.

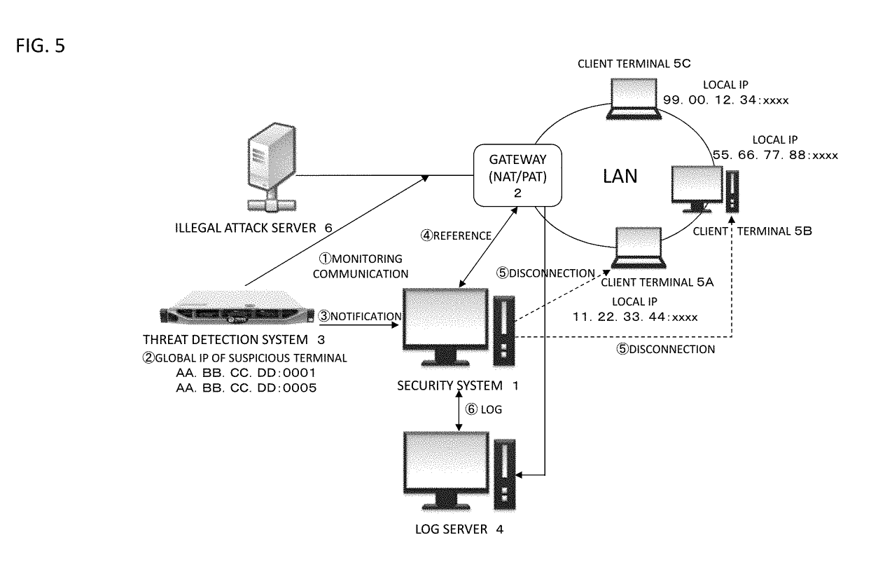

Next, a processing example by the security system 1 according the embodiment of the present invention is described with reference to FIG. 5. In FIG. 5, it is assumed that the illegal attack server 6 in the global network launches a cyber attack against the client terminals 5A and 5B, and the local address and the global address of the client terminal 5 are shown in FIG. 4.

The threat detection system 3 monitors communication to the private network, detects a threat from the illegal attack server 6, and specifies the IP address of the transmission destination from the packet. Then, the threat detection system 3 recognizes the IP address as the global address of the client terminal 5 to be attacked. For example, it is assumed that a threat against the client terminals 5 which use the global addresses “AA.BB.CC.DD:0001” and “AA.BB.CC.DD:0005” is detected (S100).

When detecting the threat, the threat detection system 3 notifies the security system 1 of the threat and the global addresses to be attacked of “AA.BB.CC.DD:0001” and “AA.BB.CC.DD:0005” (S110). When receiving the notification of the threat and the global addresses to be attacked of “AA.BB.CC.DD:0001” and “AA.BB.CC.DD:0005” from the threat detection system 3, the security system 1 refers to the NAT/PAT translation table of the NAT/PAT router which is the gateway 2 based on the global addresses of “AA.BB.CC.DD:0001” and “AA.BB.CC.DD:0005”, and specifies the corresponding local addresses (S120).

In other words, the security system 1 specifies the local addresses corresponding to the received global addresses of “AA.BB.CC.DD:0001” and “AA.BB.CC.DD:0005”. With reference to FIGS. 4 and 5, the security system 1 specifies that the local address of “11.22.33.44:xxxx” corresponds to the global address of “AA.BB.CC.DD:0001”, and that the local address of “55.66.77.88:xxxx” corresponds to the global address of “AA.BB.CC.DD:0005”.

Then, the security system 1 disconnects, based on the specified local addresses, the communication of the client terminals 5A and 5B which use the local addresses in the private network (S130). Furthermore, the security system 1 notifies the log server 4 that the control processing to disconnect the communication of the client terminal 5A having the local address of “11.22.33.44:xxxx” and the client terminal 5B having the local address of “55.66.77.88: xxxx” has been performed together with the date and time information, and causes the log server 4 to record the notification.

Note that, when the security system 1 disconnects the communication of the client terminals 5A and 5B, the switch, which is connected to each client terminal 5 with a port and relays the communication in the private network, performs the disconnection. Thus, the security system 1 transmits to the switch a control instruction to disconnect the communication, and the switch disconnects the communication in response to the instruction.

For example, in the case of a network constructed with a software defined network (SDN), such as the OpenFlow, an SDN controller (OpenFlow controller) can be used as the security system 1. The SDN controller is software to control and manage the network, and passes, to a switch, such as an OpenFlow switch which is a network device to transfer data in a private network, such as a LAN, a control instruction indicating how to proceed the packet received from the client terminal. Furthermore, the switch stores a rule table (flow entry) indicating a rule showing how to control a packet, and processes the packet according to the rule. When a rule is not in the rule table, the processing of the packet is suspended, and the suspended packet is processed according to a control instruction from the SDN controller after inquiring of the SDN controller. Alternatively, in some cases, the packet is transmitted to the SDN controller and rewritten by the SDN controller, and the rewritten packet is received from the SDN controller and processed.

Thus, in the case of the network constructed with the SDN, when the security system 1 which is the SDN controller specifies the local address and receives an inquiry about processing of the packet from the switch, passes, to the switch, the control instruction to discard the packet including the local address if the switch specifies that the local address is included as the transmission source address of the packet. Then, the switch discards the packet based on the control instruction. Furthermore, the security system 1 writes, in the rule table of the switch, a rule for the transmission source to perform the control to discard the packet having the specified local address. Thereafter, it is possible for the switch to discard the packet having the specified local address without inquiring of the security system 1, and disconnect the communication accordingly.

By the above processing, it is possible to perform predetermined control processing for a defense, such as disconnection or the like of the communication of the client terminal 5, although the security system 1 is provided outside the private network. Furthermore, since the log server 4 records the control processing, the control processing can be checked later.

In the above description, the security system 1 refers to, based on the global address received from the threat detection system 3, the NAT/PAT translation table of the NAT/PAT router which is the gateway 2, and specifies the corresponding local address, but may specify the corresponding local address from the log server 4. In other words, since the log server 4 receives and records the history of the NAT/PAT translation together with the time stamp from the gateway 2, the corresponding local address can be specified by referring to the log server 4 based on the date and time information indicating when the threat is detected and the global address received from the threat detection system 3. Furthermore, based on the specified local address, the control processing performed to the client terminal 5 using the local address may be specified.

Moreover, at the time when receiving the date and time information indicating when the threat is detected and the global address from the threat detection system 3 if there is a predetermined interval (for example, five or ten minutes, or an hour) between the received date and time information and the date and time information indicating when the threat is detected, the security system 1 may specify the local address in the date and time information indicating when the threat is detected by not referring to the NAT/PAT translation table of the gateway 2 but by referring to the NAT/PAT translation and the time stamp information recorded in the log server 4 and received from the gateway 2 based on the date and time information indicating when the threat is detected. When the notification from the threat detection system 3 to the security system 1 is delayed for some reason, the NAT/PAT translation table can be rewritten. In this case, if the NAT/PAT translation table of the gateway 2 is referred to at the time when the notification is received, a different local address can be specified. Thus, by referring to the log server 4, it is possible to correctly specify the local address corresponding to the global address at the time when the threat is detected, and for the security system 1 to control the client terminal 5.

### INDUSTRIAL APPLICABILITY

By using a security system 1 according to an embodiment of the present invention, it is possible to specify a client terminal 5 in a private network although the security system 1 operates outside the private network. Then, by specifying the damaged client terminal 5, it is possible to perform disconnection or the like only of the communication of the client terminal 5. Thus, other client terminals 5 which do not receive an attack in the private network are not affected.

What is claimed is:

1. A security system which performs predetermined control processing to a computer in a private network and is provided outside the private network, wherein the security system is configured to:
receive a global address which is a target of a threat from a threat detection system which detects the threat from an illegal attack server;
specify a local address corresponding to the received global address by referring to, based on the received global address, a translation table, which is included in a gateway in the private network, between the global address and the local address; and
perform, from outside of the private network, predetermined control processing to communication of the computer in the private network using the specified local address.

2. The security system according to claim 1, wherein
the security system is further configured to causes, by notifying the computer in the private network of performed control processing and date and time information, a log server to record the performed control processing.

3. A security system provided outside a private network, wherein the security system is configured to:
receive a global address which is a target of a threat and date and time information indicating when the threat is detected from a threat detection system which detects the threat from an illegal attack server; and
specify a local address corresponding to the global address at a time when the threat is detected by referring to, based on the received date and time information and the received global address, a log server which records a correspondence relation between a time stamp and information on translation between the global address and the local address in a gateway in the private network.

4. A security processing method in a computer network including a security system provided outside a private network, a threat detection system configured to detect a threat from an illegal attack server, and a gateway, which includes a translation table between a global address and a local address, in the private network, the security processing method comprising:
receiving, by the security system, a global address which is a target of the threat from the threat detection system which detects the threat from the illegal attack server;
specifying, by the security system, a local address corresponding to the global address by referring to, based on the received global address, a translation table of the gateway; and
performing, by the security system, predetermined control processing to communication of the computer in the private network using the specified local address.

5. A security processing method in a computer network including a security system provided outside a private network, a threat detection system configured to detect a threat from an illegal attack server, and a log server configured to record a correspondence relation between a time stamp and information on translation between a global address and a local address in a gateway configured to translate the global address and the local address in the private network, the security processing method comprising:
receiving, by the security system, a global address which is a target of the threat and date and time information indicating when the threat is detected from a threat detection system which detects the threat from the illegal attack server; and
specifying, by the security system, a local address corresponding to the global address at a time when the threat is detected by referring to the log server based on the received date and time information and the received global address.
